(19) United States
(12) Patent Application Publication
(10) Pub. No.: US 2024/0265563 A1
(43) Pub. Date: Aug. 8, 2024

(54) PASSIVE 3D IMAGING METHOD BASED ON OPTICAL INTERFERENCE COMPUTATIONAL IMAGING

(71) Applicant: Shanghai Institute of Technical Physics, Chinese Academy of Sciences, Shanghai (CN)

(72) Inventor: Qinghua YU, Shanghai (CN)

(21) Appl. No.: 18/634,871

(22) Filed: Apr. 12, 2024

Related U.S. Application Data
(63) Continuation of application No. PCT/CN2023/105819, filed on Jul. 5, 2023.

(30) Foreign Application Priority Data
Jul. 11, 2022 (CN) 202210811547.4

(51) Int. Cl. G06T 7/593; G06T 5/60; G06T 7/80

(52) U.S. Cl. CPC G06T 7/593; G06T 5/60; G06T 7/80; G06T 2207/10021; G06T 2207/20081; G06T 2207/20084

(57) ABSTRACT

A passive 3D imaging method based on an optical interference computational imaging comprises adopting an optical interference computational imaging system with the non-overlapped baseline midpoints to acquire the object mutual intensity in the spatial frequency domain, then adjusting the reference working distance step by step for phase compensation and image reconstruction, finally relying on an image optimization evaluation algorithm to obtain a clear image and 3D coordinate information of the interested target. The method enables to passively acquire object information through single exposure by using one optical interference computational imaging system, and to obtain the clear image and 3D coordinate of the object according to the image optimization evaluation algorithm and has the advantages of wide applicability and high efficiency.

### CROSS-REFERENCE TO RELATED APPLICATIONS

The subject application is a continuation of PCT/CN2023/105819 filed on Jul. 5, 2023, which claims priority on Chinese patent application no. 202210811547.4 filed on Jul. 11, 2022 in China. The contents and subject matters of the PCT and Chinese priority applications are incorporated herein by reference.

### TECHNICAL FIELD

The present invention belongs to the field of optoelectronic imaging and provides a passive 3D imaging method based on optical interference computational imaging. The method plays an important role in scientific exploration, national defense, space exploration, and other fields.

### BACKGROUND

3D imaging technology is utilized to obtain 3D information of targets. After decades of development, 3D imaging technology has been widely applied in fields such as biomedicine, automatic driving, and topographic exploration, and has important research value. At present, vision-based 3D imaging methods are mainly divided into active methods and passive methods, where the active methods mainly include laser scanning method, structured light method, and time-of-flight method. According to these methods, an active light source is introduced to illuminate the target, and 3D information of the target is inferred according to the changes in light intensity or phase so that the weak light targets or even the light free targets can be detected. The passive methods mainly include monocular focus degree analysis method, binocular feature point matching method, and multi-ocular image fusion method. By use of these methods, the 3D model of targets can be reconstructed by analyzing photos taken through multiple exposures or multiple cameras. In summary, various 3D imaging methods have been proposed in succession, and 3D imaging has become a hot topic in academic research and industrial applications.

In recent years, scientists have proposed a photonics integrated interference imaging system that combines the principle of interference imaging with photonic integration technology. See U.S. Pat. No. 8,913,859B1. Differing from traditional spatial imaging, the photonics integrated interference imaging system acquires light passing through paired aperture arrays located on an equivalent pupil plane and uses a waveguide array located behind each aperture to obtain a large field of view (FOV). The light from each sub-FOV is transmitted and processed by a grating beam splitter and a phase retarder in the optical path before entering into orthogonal detectors to generate photoelectric current. Each pair of lenses forms an interference baseline, and the corresponding photoelectric current can be converted into a mutual intensity signal at a specific spatial frequency. After obtaining an appropriate amount of mutual intensity sampling at a certain spatial frequency through a certain number of interference baselines, a 2D reconstructed image can be obtained through 2D Fourier transform. The photonics integrated interference imaging system can be designed with various lens array structures in radial (U.S. Pat. No. 8,913,859B1), hexagonal and checkerboard (Chinese Patent No. CN202010965700.X) shapes, and the capability of acquiring spatial frequency information in single-distance ideal 2D target scenes with various structural forms has been studied, but the impact of depth of field (distance) of the target and the configuration of the interference baseline of the system has been ignored. However, the capability of 3D imaging has not been discussed in current research.

### SUMMARY OF INVENTION

The present invention focuses on the impact of depth of field (distance) of target and system interference baseline configuration on the quality of imaging through the photonics integrated interference imaging system. In the present invention, signals acquired through the system are corrected by introducing a reference working distance and combining the baseline configuration. Studies on the impact of adjusting the reference working distance on the sharpness of the reconstructed image show that when baseline midpoints of the optical interference imaging system are not completely overlapped, the reference working distance where the target image is the clearest is just the sole actual working distance. On this basis, a passive 3D imaging method based on an optical interference computational imaging method is proposed, which provides a new solution for 3D imaging.

The present invention enables to passively acquire object information through single exposure by using one optical interference computational imaging system, and to obtain a clear image and 3D coordinate data of the object according to the image optimization evaluation algorithm and has the advantages of wide applicability and high efficiency.

The working principle of the optical interference computational imaging system is to acquire the mutual intensity of the object through each interference baseline located on an equivalent pupil plane and then reconstruct the image through 2D Fourier transform.

According to the linear properties of Fourier transform, the reconstructed image can be regarded as superposition of inversion images after the 2D Fourier transform of signals acquired through each interference baseline.

According to the Van Cittert-Zernike Theorem, the mutual intensity J of the acquired light at the coordinates (x₁,y₁) and (x₂,y₂) of each pair of lenses that form an arbitrary interference baseline on an equivalent pupil plane lens array plane of the optical interference computational imaging system is:

$$J ( {x}_{1} , {y}_{1} ; {x}_{2} , {y}_{2} ) = \frac{exp ( j φ )}{{( λ z )}^{2}} \int {\int }_{- ∞}^{∞} I ( α , β ) \times exp \{ - j \frac{2 π}{λ z} ( Δ x α + Δ y β ) \} d α d β \qquad ( 1 )$$

where λ is the wavelength, z is the target distance, 1(α, β) is the intensity distribution of the target, Δx=x₂−x₁, and Δy=y₂−y₁ are the distance between the paired lenses, namely the baseline B. A phase factor 4 is

$$φ = \frac{π}{λ z} ( ( {x}_{2}^{2} + {y}_{2}^{2} ) - ( {x}_{1}^{2} + {y}_{1}^{2} ) ) \qquad ( 2 )$$

the spatial frequency domain of acquisition through each aperture pair is:

$$( u , v ) = \frac{1}{λ z} ( Δ x , Δ y ) \qquad ( 3 )$$

Then, the mutual intensity J can be expressed as:

$$J ( {x}_{1} , {y}_{1} ; {x}_{2} , {y}_{2} ) = \frac{1}{{( λ z )}^{2}} exp [ j 2 π ( {ux}_{m} + {vy}_{m} ) ] \cdot F [ I ( α , β ) ] {\vert}_{u , v} \qquad ( 4 )$$

where

$${x}_{m} = \frac{{x}_{1} + {x}_{2}}{2} and {y}_{m} = \frac{{y}_{1} + {y}_{2}}{2}$$

are midpoints of the aperture pair,

$$F [ I ( α , β ) ] {\vert}_{u , v} = \int {\int }_{- ∞}^{∞} I ( α , β ) \times exp \{ - j 2 π ( u α + v β ) \} d α d β$$

is the result of 2D Fourier transform of 1(α, β) about (u, v), that is, the mutual intensity at the spatial frequency domain (u, v) of the object corresponding to the aperture pair (x₁,y₁) and (x₂,y₂). It can be seen that the signal acquired through the aperture pair, namely the mutual intensity J, is related to the spatial frequency domain (u, v) of the target, the target distance z and the baseline midpoint (xₘ, yₘ).

In a practical working scenario, the actual working distance z of a target is usually unknown, so a reference working distance z_{c} is introduced. In order to discuss the impact of the actual working distance z and the reference working distance z_{c} respectively, a correction term J_{c} is applied to an acquired signal, which includes aperture pair coordinates and the set reference working distance z_{c}:

$${J}_{c} = exp ( j {φ}_{c} ) = exp \{ - \frac{π}{λ {z}_{c}} [ ( {x}_{2}^{2} + {y}_{2}^{2} ) - ( {x}_{1}^{2} + {y}_{1}^{2} ) ] \} \qquad ( 5 )$$

By combining the formulas (4) and (5), a corrected signal J·J_{c} can be expressed as:

$$J \cdot {J}_{c} = \frac{1}{{( λ z )}^{2}} exp [ j 2 π ( {ux}_{m} + {vy}_{m} ) ( 1 - \frac{z}{{z}_{c}} ) ] \cdot F [ I ( α , β ) ] {\vert}_{u , v} \qquad ( 6 )$$

According to the displacement property of the 2D Fourier transform, it is known that

$$J \cdot {J}_{c} ∝ F [ I [ α + {x}_{m} ( 1 - \frac{z}{{z}_{c}} ) , β + {y}_{m} ( 1 - \frac{z}{{z}_{c}} ) ] ] {\vert}_{u , v} ,$$

which is the 2D Fourier transform after spatial translation of the object. In consideration of periodicity of the 2D Fourier transform, an image translation amount is

$${s}_{0} = ( - {x}_{m} ( 1 - \frac{z}{{z}_{c}} ) + a {T}_{x} , - {y}_{m} ( 1 - \frac{z}{{z}_{c}} ) + b {T}_{y} ) \qquad ( 7 )$$

where

$${T}_{x} = \frac{1}{u} , {T}_{y} = \frac{1}{v}$$

are the periods of the inversion image, and a and b are any integers. It can be seen that an inversion image obtained from an interference baseline signal after the 2D Fourier transform is accompanied by translation of s₀. To measure the impact of the translation of the inversion image on the reconstructed image, the ratio of the translation amount s₀ to the size of the reconstructed image, i.e. the image deviation, can be used to evaluate. The size of the reconstructed image is the size of FOV, which is calculated as

$${L}_{x} = \frac{λ z}{{B}_{{min}_{x}}} and {L}_{y} = \frac{λ z}{{B}_{{min}_{y}}} ,$$

where Bₘᵢₙ_{ₓ} and Bₘᵢₙ_{_{y}} are two shortest baselines in an orthogonal direction. Therefore, the image deviation of the inversion image can be normalized as follows according to the size of FOV:

$$s = ( - \frac{{x}_{m}}{{L}_{x}} ( 1 - \frac{z}{{z}_{c}} ) + a \frac{{T}_{x}}{{L}_{x}} , - \frac{{y}_{m}}{{L}_{y}} ( 1 - \frac{z}{{z}_{c}} ) + b \frac{{T}_{y}}{{L}_{y}} ) \qquad ( 8 )$$

s decreases with the increase in the size of FOV, and increases with the increase in a midpoint deviation, that is, the deviation between the interference baseline midpoint (xₘ, yₘ) and the optical axis center, which is also related to the value of z_{c}. For different interference baselines, s has different values, and corresponding inversion images are deviated to varying degrees, which affects the sharpness of the reconstructed images.

In essence, after spatial frequency domain decomposition, the object image can be deemed as a superposition of original inversion images corresponding to a series of spatial frequencies. The imaging system uses different interference baselines for sampling at specific spatial frequencies and forming reconstructed images. When the distance z of a target is far away, the size of FOV is much larger than the midpoint deviation, that is, Lₓ>>xₘ and L_{y}>>yₘ. All s approach

$$( a \frac{{T}_{x}}{{L}_{x}} , b \frac{{T}_{y}}{{L}_{y}} ) ,$$

which, according to periodicity, are equivalent to (0,0). When all inversion images are at proper positions, the reconstructed images will be clear. But when the target distance is not too far, the impact of the midpoint deviation will become apparent. When the coordinates of midpoints of all interference baselines are the same but not zero, all s can take the same value, all inversion images have the same deviation, and the reconstructed images are clear but there exists a translation deviation. For an imaging system with non-overlapping interference baseline midpoints, the value and dispersion degree of the image deviation s can be changed by adjusting the value of z_{c}. When

$${z}_{c} = z , 1 - \frac{z}{{z}_{c}} = 0 ,$$

all s can take the same value (a, b), which, according to periodicity, are equivalent to (0,0), and in this case, the reconstructed images are clear; in addition, when z_{c} is in the vicinity of z, but z_{c}≠z, all s are discrete, and the image deviation of each inversion image is discrete, a fuzzy reconstructed image is obtained in that circumstance just like that where various colors are not aligned when printing a newspaper. Therefore, within a range of the actual working distance of target, only when z_{c}=z, the reconstructed image is clear, and as z_{c} is away from z, the reconstructed image will become increasingly fuzzy.

Based on the above working principle, the present invention provides a passive 3D imaging method based on an optical interference computational imaging method. Baseline midpoints of an aperture pair array adopted for the imaging method are relatively discrete. For example, when the baseline midpoints formed by each aperture pair are not overlapped or at least there are a few midpoints non-overlapping in the optical interference computational imaging systems, interference recording of the mutual intensity of the object is performed. Then, with the help of the image optimization evaluation algorithms, the sharpness of images reconstructed through step by step adjustment of the reference working distance is analyzed, and the clearest reconstructed image and the corresponding reference working distance are obtained. Finally, a relative position and size of the target are calculated based on an optimal reference working distance and the clearest reconstructed image, to complete 3D imaging of the object. The method of the present invention is a passive 3D imaging method of single exposure with one camera. Key steps of 3D imaging are as follows:
S1: An optical interference computational imaging system with relatively discrete baseline midpoints of the aperture pair array is used to perform interference recording of the mutual intensity of the object, which means the baseline midpoints formed by each aperture pair are not overlapped or at least there are a few midpoints non-overlapping in the optical interference computational imaging systems;
S2: The reference working distance is adjusted step by step within a certain range, and the phase of mutual intensities of each spatial frequency corresponding to the baseline for each aperture pair is compensated, and then the object image is reconstructed by Fourier transform algorithm;
S3: The sharpness of each reconstructed target image is evaluated by using the image optimization evaluation algorithm, and the reconstructed image with clear scene or locally clear scene and the corresponding reference working distance are obtained;
S4: Based on the clear or locally clear image and the corresponding reference working distance, the relative position and size information of the object of interest in the image are calculated, and then the 3D image of the object scene is reconstructed, and the passive 3D imaging and image reconstruction of the object scene are completed.

### BRIEF DESCRIPTION OF THE DRAWINGS

FIG. 1 is a flowchart showing the passive 3D imaging method implementation scheme in the present invention.

FIG. 2 shows the composition and working principle of a checkerboard imager in Example 1 of the present invention, where A is an aperture pair array for acquiring object light, B is a 2D Photonic Integrated Circuit (PIC) optical waveguide array for beam splitting, C is a 3D optical waveguide array for transmitting light beams and matching optical path differences, D is a 2D PIC optical waveguide array for aperture pair coherence, and E is a readout circuit and data processing system, where B.1 is a waveguide array cross-section, B.2 is a splitting grating, E.1 is a phase retarder, and E.2 is a balanced quadri-orthogonal coupler.

FIGS. 3A to 3F show resolutions of the reconstructed images at different reference working distances in Example 1 of the present invention, where FIG. 3A shows an image of the target pattern input for simulation, FIG. 3B shows the reconstructed image at z_{c} being infinity, FIG. 3C shows the reconstructed image at z_{c} being 1500 m, FIG. 3D shows the reconstructed image at z_{c} being 1000 m, FIG. 3E shows the reconstructed image at z_{c} being 1475 m, and FIG. 3F shows the reconstructed image at z_{c} being 1550 m.

FIG. 4 shows the relationship between the reference working distance and the sharpness of the reconstructed image for the object scene with a single working distance, where the dashed line shows the evaluation according to the Laplace gradient function, and the solid line shows the evaluation according to the structural similarity in the present invention. The vertical axis is the evaluation function.

FIGS. 5A to 5D show the 3D imaging simulation scene in Example 2 of the present invention, where FIG. 5A shows the scene diagram of the spatial relative positions between an imager, an unmanned aerial vehicle (UAV), and the ground, where F is the imager and G is the UAV; FIG. 5B shows the shape of the UAV; FIG. 5C shows the ground image including the UAV projection; and FIG. 5D shows the image of the “automobile” area.

FIG. 6 shows the relationship between the sharpness of the reconstructed image and the reference distance value is evaluated by Laplacian gradient function under the condition of object scene at different working distances in Example 2 of the present invention. The solid line is the sharpness curve of the drone area image, and the dashed line is the sharpness curve of the car area image. The vertical axis is evaluation function.

FIGS. 7A to 7F show the simulation results of the target at different distances in Example 2 of the present invention, where FIG. 7A shows the reconstructed image with the reference working distance of 8.034 km; FIG. 7B shows the reconstructed image with the reference working distance of 9.997 km; FIG. 7C shows the reconstructed image of UAV area with the reference working distance of 8.034 km; FIG. 7D shows the reconstructed image of “automobile” area with the reference working distance of 8.034 km; FIG. 7E shows the reconstructed image of UAV area with a reference working distance of 9.997 km; and FIG. 7F shows the reconstructed image of “automobile” area with a reference working distance of 9.997 km.

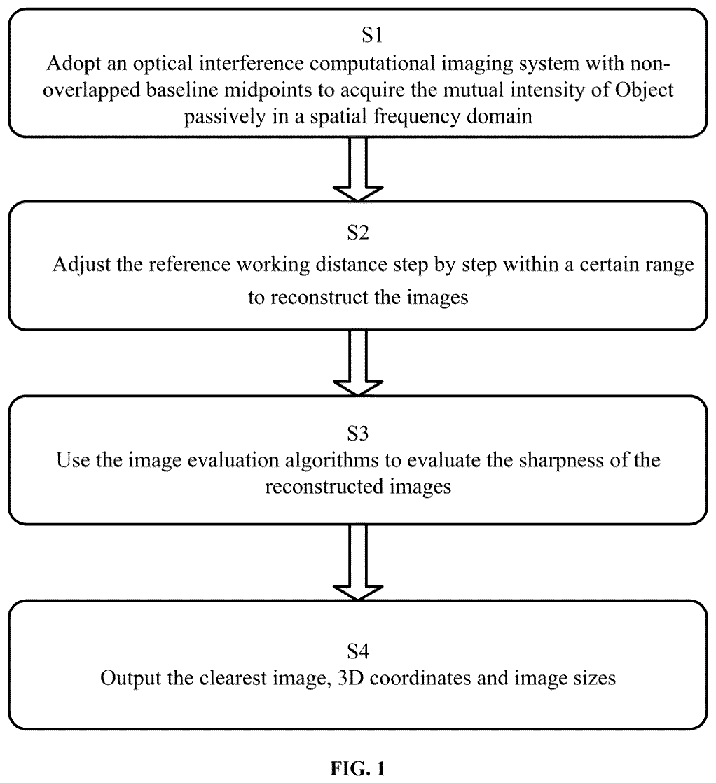

### DETAILED DESCRIPTION OF THE INVENTION AND EMBODIMENTS

### Example 1: 3D Imaging Results of the Target Scene at a Single Distance

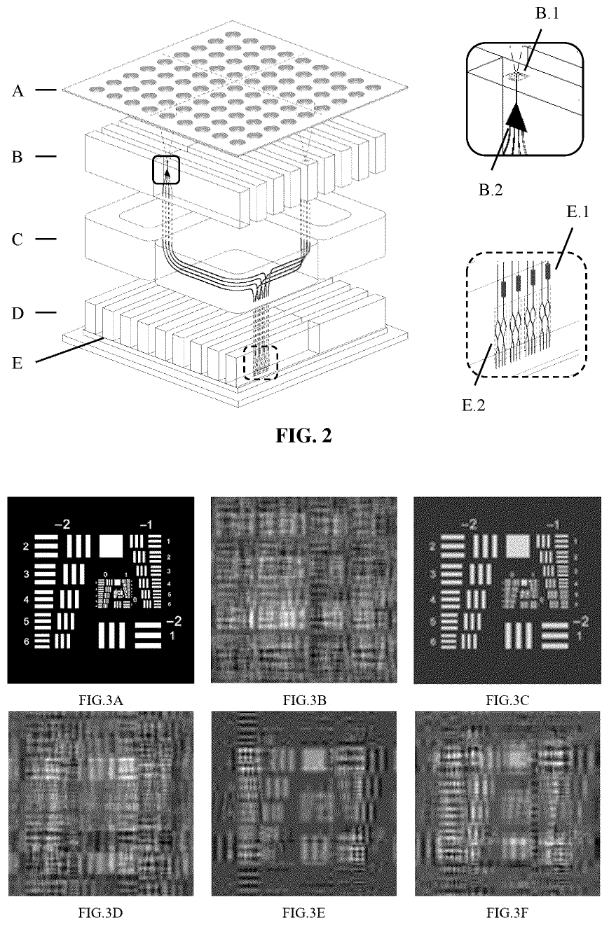

The “checkerboard” imager is taken as an example to analyze the 3D imaging effect. The “checkerboard” imager is based on the principle of optical interference computational imaging, and the aperture of the lens array is arranged in a (2N+1)×(2N+1) matrix. FIG. 2 shows the composition and working principle of the checkerboard imager, where A is an aperture pair array for acquiring object light, B is a 2D Photonic Integrated Circuit (PIC) optical waveguide array for beam splitting, C is a 3D optical waveguide array for transmitting light beams and matching optical path differences, D is a 2D PIC optical waveguide array for aperture pair coherence, and E is a readout circuit and data processing system, where B.1 is a waveguide array cross-section, B.2 is a splitting grating, and E.1 is a phase retarder, E.2 is a balanced quadri-orthogonal coupler.

Parameters of the imager and the target are shown in Table 1. The midpoints of an interference baseline of the “checkerboard” imager are dispersed in four points: (0.051 m, 0.051 m), (0.051 m, −0.050 m), (−0.050 m, 0.051 m), and (−0.050 m, −0.050 m). the target pattern shown in FIG. 3A is selected as the image input for simulation.

The simulation process is as follows: optical information of the object scene is coupled into the optical waveguide array through the lens array and split by the grating. After light passing through the phase retarder and balanced quadri-orthogonal coupler, a photoelectric current is obtained. A corrected acquisition signal is calculated according to the photoelectric current and the reference working distance, and a reconstructed image is obtained by Fourier transform.

During the reconstruction process, corresponding reconstructed images are obtained at the reference working distance z_{c} sequentially changed from 500 m to 2500 m, where reconstructed images with z_{c} being infinity, 1500 m, 1000 m, 1475 m and 1550 m respectively are shown in FIGS. 3B to 3F, where the actual working distance z is 1500 mm. The image reconstructed when z_{c} has an infinite deviation is shown in FIG. 3B. The midpoints of the interference baselines have four different values, that is, the deviations of the reconstructed images are four different values, resulting in that fuzzy images are obtained after the reconstructed images are overlapped with each other. The reconstructed image obtained when z_{c}=1500 m is shown in FIG. 3C. That is, when the actual working distance serves as the reference working distance, after the deviations of the reconstructed images at each frequency spectrum are effectively corrected, the reconstructed images are overlapped again to obtain a clearer image. It can be seen from FIGS. 3D to 3F that the reference working distance is deviated from the actual working distance, and the deviations of the reconstructed images are four different values, resulting in that the images obtained after overlapping the reconstructed images are fuzzy to varying degrees.

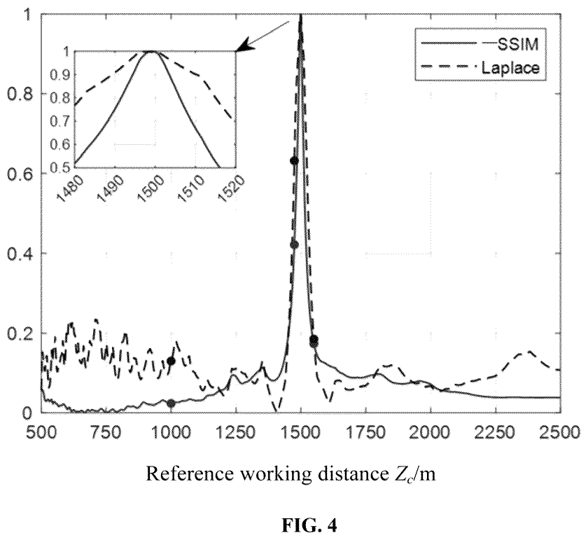

The normalized results of image sharpness evaluation function for each reconstructed image based on a Laplace gradient function are shown by the dashed line in FIG. 4. The normalized results of image sharpness evaluation function for each reconstructed image based on the negative value of structural similarity and the filtered images after removing the highest frequency are represented by the solid line in FIG. 4. It can be seen that two evaluation functions both exhibit good unimodality, and the evaluation functions based on the Laplace gradient function and the structural similarity reach their maximum values at 1496.48 m and 1499.22 m respectively, which are very close to the actual working distance of the target. The evaluation function based on the Laplace gradient function is limited in performance but can be used for analyzing local patterns. The evaluation function based on the structural similarity has smaller oscillations when the reference working distance is far from the actual working distance and has a smaller half-peak breadth at the position near the actual working distance but is only suitable for evaluating the overall images. An estimated distance of the target is 1499.22 m, and the size of the target, according to a working wavelength and a minimum baseline, is calculated to be 0.4498 m×0.4498 m, which approaches an actual size of the target. It can be seen that, based on this imaging method, for the work scene of single distance, the peak search algorithm can be used to find the extreme position of the evaluation function, and then the best reference working distance is used as the target estimate distance, so as to obtain the size of the target and a clear image.

TABLE 1
Parameters of the Checkerboard Imager and the Target

| Parameter | Value | |
|---|---|---|
| Lens array parameter N | 50 | |
| Overall size of lens array | 101 × 101 | |
| Minimum baseline Bₘᵢₙ | 0.002 | m |
| Single lens diameter d | 0.002 | m |
| System diameter D | 0.283 | m |
| Waveguide array behind each lens | 1 × 1 | |
| Working wavelength λ | 600 | nm |
| Imaging field of view FOV_{single} | 0.0172° | |
| Target distance z | 1500 | m |
| Target size L | 0.450 | m |

### Example 2: 3D Imaging Results of the Target at Different Distances

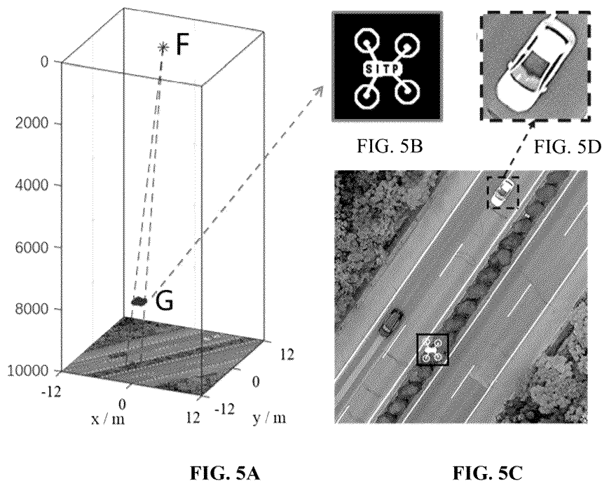

In this example, the “checkerboard” aperture layout in Example 1 is still adopted, and imaging parameters are shown in Table 2. The midpoints of the interference baselines are dispersed in the centers of four parts: (0.0765 m, 0.0765 m), (0.0765 m, −0.075 m), (−0.075 m, 0.0765 m), and (−0.075 m, −0.075 m). In view that the distances of targets within FOV are not unique and there is an occlusion scene therein, as shown in FIG. 5A, it is assumed that an imager F installed in a reconnaissance plane performs imaging a section of road from an altitude of z₁=10 km above the ground. Assuming that the coordinate of the imager F is (0 m, 0 m, 0 m), and the side length of the ground imaging area is Lₚ=FOV_{Z}_{₁}=24 m. In this case, an unmanned aerial vehicle (UAV) G flies over the road from the altitude of 2 km, with the size of 1.79 m×1.43 m, and the center point coordinate of (−2.19 m, −4.00 m, 8000 m). Its shape is shown in FIG. 5B. that is, the distance between the UAV G and the imager F is z₂=8 km. An image of the scene is shown in FIG. 5C, including the projection of the UAV on the ground. An automobile area used for comparison is shown in FIG. 5D, where the center point coordinate is (3.96 m, 9.83 m, 10000 m), and the length of the white automobile is 2.83 m.

TABLE 2
Parameters of Checkerboard Imager and the Target

| Parameter | Value | |
|---|---|---|
| Lens array parameter N | 50 | |
| Overall size of lens array | 101 × 101 | |
| Minimum baseline Bₘᵢₙ | 0.003 | m |
| Single lens diameter d | 0.002 | m |
| System diameter D | 0.424 | m |
| Waveguide array behind each lens | 9 × 9 | |
| Working wavelength λ | 800 | nm |

| | |
|---|---|
| Imaging field of view FOV | 0.1375° |

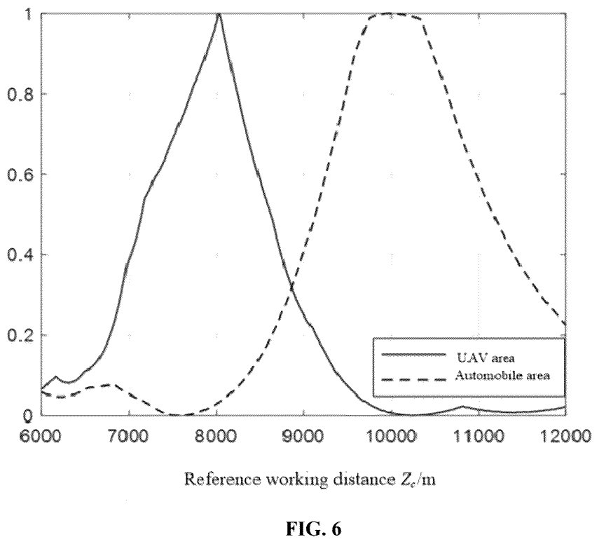

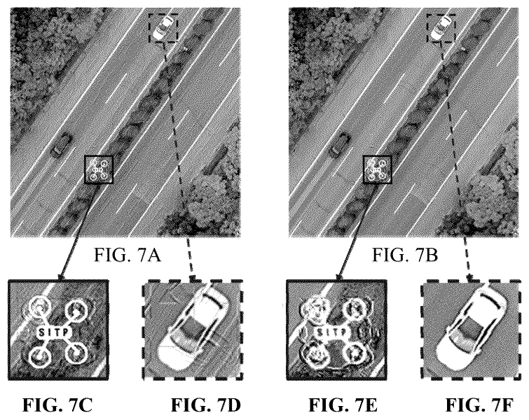

In the same simulation process, the reconstructed images are obtained at the reference working distance z_{c} sequentially changed from 6 km to 12 km. A Laplace gradient is used as an evaluation function to evaluate the reconstructed images of the “UAV area” and the “automobile area”. Results are shown in FIG. 6, and maximum values are reached at 8.034 km and 9.997 km, respectively. Reconstructed images obtained when a reference working distance z_{c} is 8.034 km and 9.997 km respectively are shown in FIG. 7A and FIG. 7B. FIGS. 7C to 7F show the reconstructed images of the “UAV area” and the “automobile area”, respectively. Among them, FIG. 7C shows the image of the UAV area at a reference distance of 8.034 km, and FIG. 7D shows the image of the automobile area at a reference distance of 8.034 km. It can be seen that when the reference working distance is 8.034 km, the reconstructed images of the ground part are relatively fuzzy with fringes. FIG. 7E shows an image of the UAV area at a reference distance of 9.997 km, and FIG. 7F shows an image of the “automobile” area at a reference distance of 9.997 km. It can be seen that when the reference working distance is 9.997 km, the images of the ground part are relatively clear, and only the resolution of the images of the UAV area is affected. It can be seen therefrom that when the reference working distance approaches the actual working distance of the UAV, the images of the UAV are clearer but the images of the automobile are relatively fuzzy. When the reference working distance approaches the actual working distance of the ground, the images of the automobile are clearer but the images of the UAV are relatively fuzzy.

At the distance of 8.034 km from the UAV, the size of the reconstructed image is calculated to be 19.28 m×19.28 m, and according to the relative position of the UAV in the reconstructed image, its size is calculated to be 1.80 m×1.44 m, where the coordinate of center point is (−2.20 m, −4.02 m, 8034 m). At the distance of 9.997 km above the ground, the size of a reconstructed image is calculated to be 23.99 m×23.99 m, and according to the relative position of the automobile area in the reconstructed image, a center point coordinate is calculated to be (3.96 m, 9.82 m, 9997 m), and a length of the automobile is calculated to be 2.83 m.

The simulation experiment results show that by adjusting the reference working distance z_{c}, the sharpness of different targets in the reconstructed images can be changed, and the reference working distance z_{c} at which the reconstructed image of the interested target is the clearest is actually close to the actual working distance. By using some image segmentation methods and auto-focus algorithms to find out the reference working distance values that make the target images clearest, and then, the distance and size of each target can be estimated.

I claim:

1. A passive 3D imaging method based on optical interference computational imaging, comprising:
(1) providing an optical interference computational imaging system with relatively discrete baseline midpoints of an aperture pair array and performing interference recording of mutual intensity of an object, wherein the baseline midpoints formed by each aperture pair of the aperture pair array are not overlapped or at least there are a few midpoints non-overlapping in the optical interference computational imaging systems;
(2) adjusting a reference working distance step by step within a range, and compensating a phase of mutual intensities of each spatial frequency domain corresponding to the baseline for each aperture pair, and reconstructing an object image by Fourier transform algorithm to obtain a target image;
(3) evaluating sharpness of each reconstructed target image using an image optimization evaluation algorithm, and obtaining a reconstructed image with clear scene or locally clear scene and a corresponding reference working distance;
(4) based on the reconstructed image with the clear scene or the locally clear scene and the corresponding reference working distance, calculating a relative position and size of an interested object in the image, and reconstructing a 3D image of the object scene to complete a passive 3D imaging and image reconstruction of the object scene.
